(19) United States
(12) Patent Application Publication
(10) Pub. No.: US 2012/0315886 A1
(43) Pub. Date: Dec. 13, 2012

(54) METHOD AND COMMUNICATION DEVICE FOR ASSISTING MOBILE DATA OFFLOADING AND MOBILE DEVICE

(75) Inventor: Ben Lin, Taipei City (TW)

(73) Assignee: SERCOMM CORPORATION, Tapei (TW)

(21) Appl. No.: 13/491,161

(22) Filed: Jun. 7, 2012

(30) Foreign Application Priority Data
Jun. 9, 2011 (CN) 201110165716.3

(51) Int. Cl. H04W 28/08

(52) U.S. Cl. 455/419

(57) ABSTRACT

A method and communication device for assisting mobile data offloading and a mobile device are provided. An embodiment provides a method for assisting mobile data offloading. The method includes the following steps. In a mobile communication mode, a mobile communication signal is received by an auxiliary communication device for accordingly verifying whether to allow a sender of the mobile communication signal to be linked to the auxiliary communication device. If the verification passes, then the sender establishes a first communication link with the auxiliary communication device in the mobile communication mode. The network configuration information is sent to the sender through a first communication link, wherein the network configuration information is for activating the sender to enter the first wireless network mode in which network access is performed accordingly.

This application claims the benefit of People's Republic of China application Serial No. 201110165716.3, filed Jun. 9, 2011, the subject matter of which is incorporated herein by reference.

### BACKGROUND

1. Technical Field

The invention relates in general to a mobile data offloading method and device, and more particularly to a method and communication device for assisting mobile data offloading and a mobile device.

2. Description of the Related Art

The mainstream smart mobile phones are all equipped with dual-modes, that is, the mobile communication mode and the wireless LAN mode. The mobile communication mode, such as the 3rd generation (3G) mobile communication network, can be used in voice communication as well as data communication for linking to the Internet. The wireless LAN mode is simply used for going online. If the two modes are being activated all the time, power consumption would be very high and battery duration would be largely shortened. Therefore, in the smart mobile phone, the default state of the wireless LAN mode is set as OFF. The user manually activates the wireless LAN mode only when the user is within the coverage of a wireless LAN. In this manner, it is inconvenient to the user and communication resources are not effectively utilized.

### SUMMARY

Embodiments of a method and communication device for assisting mobile data offloading and a mobile device are provided. The embodiments facilitate mobile data offloading. On one hand, the mobile data offloading enables the user to go online in the wireless network mode conveniently; on the other hand, mobile data offloading enables the mobile device automatically to switch to an operation mode for getting online. Thus, unnecessary power consumption can be avoided. Besides, a variety of applications can be further developed.

According to one embodiment, a method for assisting mobile data offloading is provided. The method includes the following steps. In a mobile communication mode, a mobile communication signal is received by an auxiliary communication device for accordingly verifying whether to allow a sender of the mobile communication signal to be linked to the auxiliary communication device. If the verification passes, then the sender establishes a first communication link with the auxiliary communication device in the mobile communication mode. The network configuration information is sent to the sender through a first communication link, wherein the network configuration information is for activating the sender to enter the first wireless network mode in which network access is performed accordingly.

According to another embodiment, a communication device for assisting mobile data offloading is provided. The communication device at least includes an auxiliary communication device. In a mobile communication mode, the auxiliary communication device sends a network configuration information of a first wireless network mode to a sender corresponding to a mobile communication signal. The auxiliary communication device includes a mobile communication unit and a processing unit. The processing unit, coupled to the mobile communication unit for operating in the mobile communication mode, receives the mobile communication signal, and accordingly verifies whether to allow the sender to be linked to the auxiliary communication device. If the verification passes, then the processing unit enables the sender to establish a first communication link with the auxiliary communication device in the mobile communication mode. The processing unit sends the network configuration information to the sender through the first communication link, wherein the network configuration information is for activating the sender to enter the first wireless network mode in which network access is performed accordingly. In some embodiments, the communication device for assisting mobile data offloading can be implemented as an independent device, which can further be implemented as a wireless access device or a femtocell.

According to another embodiment, a mobile device capable of going online by way of mobile data offloading is provided. The mobile device includes a wireless communication unit, a storage unit and a processing unit. The wireless communication unit selectively performs voice and data communication in a mobile communication mode, and selectively performs data communication in a first wireless network mode. The processing unit is coupled to the wireless communication unit and the storage unit for operating the mobile device. When the mobile device, in the mobile communication mode, establishes a first communication link and obtains network configuration information of a first wireless network mode, the processing unit, in response to the network configuration information, activates the mobile device to enter the first wireless network mode in which network access is performed accordingly.

The above and other aspects will become better understood with regard to the following detailed description of the preferred but non-limiting embodiment(s). The following description is made with reference to the accompanying drawings.

### BRIEF DESCRIPTION OF THE DRAWINGS

FIG. 1 shows a communication device for assisting mobile data offloading and a mobile device according to one embodiment.

FIGS. 2A and 2B show a communication device for assisting mobile data offloading according to other embodiments.

FIG. 3 shows a flowchart of a method for assisting mobile data offloading according to one embodiment.

FIG. 4 shows a flowchart of implementing a mobile data offloading method on a mobile device according to one embodiment.

FIG. 5 shows a block diagram of a mobile device according to one embodiment, wherein the mobile device can achieve mobile data offloading in wireless LANs according to one embodiment.

### DETAILED DESCRIPTION

A number of embodiments relating to a method and communication device for assisting mobile data offloading and a mobile device are disclosed below.

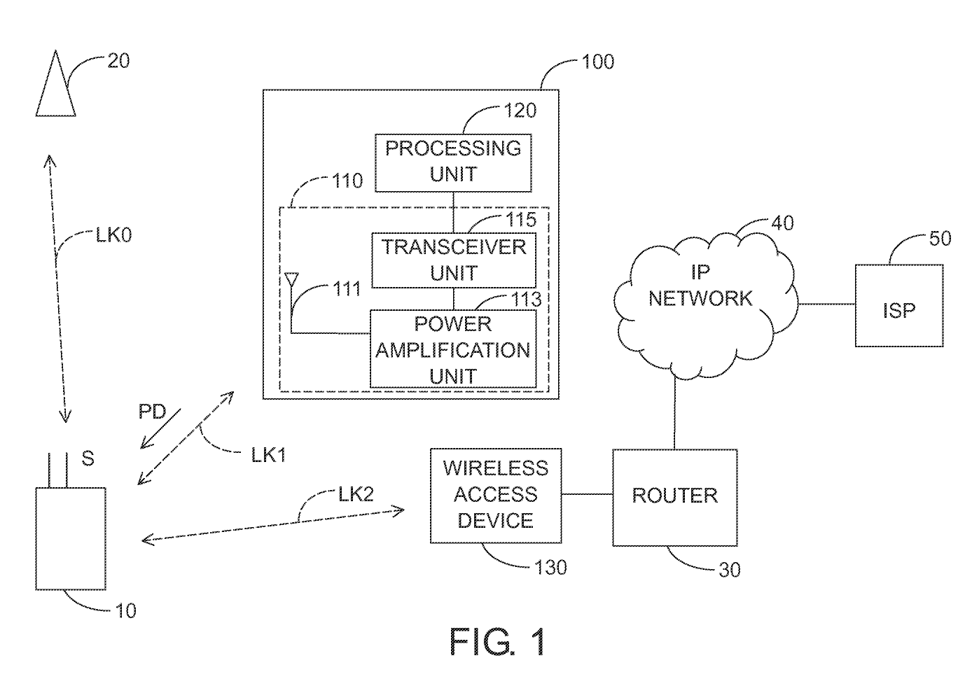

FIG. 1 shows a communication device for assisting mobile data offloading and a mobile device according to one embodiment. In FIG. 1, the mobile device 10 includes at least two different communication modes such as a mobile communication mode based on a cellular mobile communication network, and a wireless network mode based on a wireless LAN such as a communication mode based on IEEE 802.11 b/g/a/n. The mobile device 10, such as a smart mobile phone or a tablet PC, includes at least a mobile communication mode based on a cellular mobile communication network, e.g., 2nd generation (2G), 2.5nd generation (2.5G), 3rd generation (3G), 4th generation (4G), to long term evolution (LTE), LTE-advanced, WiMAX, such as mobile communication mode based on cellular mobile communication network for GSM, GPRS, WCDMA, CDMA2000, TD-SCDMA.

FIG. 1 shows an auxiliary communication device 100 which assists the communication device 10 for performing mobile data offloading. In general, for the sake of power saving and other reasons, the user usually would not activate the mobile device 10 to enter the wireless network mode. As indicated in FIG. 1, the mobile device 10 utilizes a 2G or 3G mobile communication mode to establish a communication link LK0 with a mobile communication base station 20 for performing voice communication or data communication (such as linked to the Internet). When the mobile device 10 is close to a wireless access device 130 within the coverage of a wireless LAN, the auxiliary communication device 100 enables the mobile device 10 to detect that the mobile device 10 is already within the coverage of the wireless access device 130, which has authorized the mobile device 10 to access to the network, and to automatically activate the mobile device 10 to enter the wireless network mode. For example, the mobile device 10 enters a wireless network mode to be linked to the wireless access device 130 for accessing a wired network linked to the wireless access device 130, such as an Internet protocol (IP)-based network 40. For example, the wireless access device 130 is linked to the Internet through a router 30 to be linked to an Internet service provider (ISP) 50. Through the mobile data offloading of the mobile device 10, on one hand, the user is capable of conveniently going on line in the wireless network mode; on the other hand, the mobile device 10 is automatically switched to an operation mode for internet access to avoid unnecessary power consumption.

In FIG. 1, the auxiliary communication device 100, realized by a communication device having at least a mobile communication mode (such as at least one of 2G, 3G, 4G, LTE), in a mobile communication mode, sends network configuration information of a first wireless network mode to a sender (such as the mobile device 10) corresponding to a mobile communication signal.

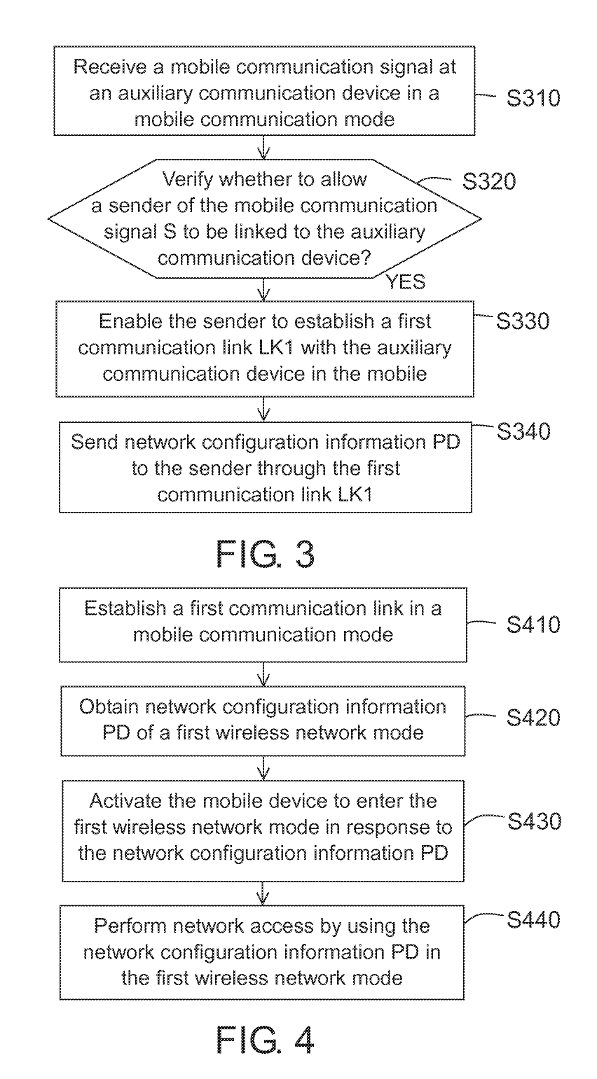

Referring to FIG. 3, FIG. 3 a flowchart of a method for assisting mobile data offloading according to one embodiment is shown. In step S310, a mobile communication signal S is received by an auxiliary communication device 100 in a mobile communication mode. In step S320, whether a sender (such as the mobile device 10) of the mobile communication signal S is allowed to be linked to the auxiliary communication device 100 is verified. In other words, step S320 can be regarded as a step for verifying whether the mobile device 10 corresponds to an authorized user. The authorized user is defined by using such as a mobile phone parameter like mobile phone number, international mobile equipment identity number (IMEI), or by a determination as to whether a user-defined parameter or password is equal to authorized user data stored in the auxiliary communication device 100. The definition of the authorized user data depends on the design of implementation. In other embodiments, the corresponding contents or conditions of the verification in step S320 may be defined according to the occasions of application or service, and may be achieved according to predefined messages in the specification of the mobile communication mode (such as 2G, 3G), and so the implementation of the step is not limited to the above exemplifications. If the verification passes, then the method proceeds to step S330, a first communication link LK1 between the auxiliary communication device 100 and the sender (such as the mobile device 10) is established in the mobile communication mode. In step S340, network configuration information PD is sent to the sender through the first communication link LK1. The network configuration information PD is used for activating the sender to enter the first wireless network mode in which network access is performed accordingly. For example, the mobile device 10 and the wireless access device 130 establish a second communication link LK2. In an embodiment, if the verification result in step S320 is negative, then no link with the mobile device 10 is established; the method indicated in FIG. 3 is not limited in this manner and the step can be implemented in other manners.

In an embodiment, after the first communication link LK1 is established, the wireless access device 130 can be set as providing network access for any device without verification. In this case, the network connection parameter data PD may include a service set identifiers (SSID) alone. In other embodiments, corresponding network configuration information PD can be provided as per required for the connection or verification in the first wireless network mode, so that the mobile device 10 can be successfully linked to the wireless access device 130. For example, if the wireless access device 130 adopts safety authentication or security technology, then the network configuration information PD may include wireless LAN SSID, password or other security setting such as related setting parameters, such as the key, conformed to one of the technologies: Wi-Fi protected access—pre-shared key (WPA-PSK), WPA2, IEEE 802.1x/RADIUS, wireless distribution system (WDS), wired equivalent privacy (WEP), temporal key integrity protocol (TKIP), or advanced encryption standard-counter mode with cipher block chaining message authentication code protocol (AES-CCMP). Thus, the network configuration information PD is further used for the sender to pass the verification by using the network configuration information PD so as to perform network access in the first wireless network mode.

Referring to FIG. 1, the auxiliary communication device 100 can be used for implementing the method for assisting mobile data offloading as indicated in FIG. 3. In an embodiment, the auxiliary communication device 100 includes a mobile communication unit 110 and a processing unit 120.

The mobile communication unit 110 is used for wireless signal transmission and receiving, and includes such as an antenna 111, a power amplification unit 113, and a transceiver unit 115. The antenna 111 is coupled to the power amplification unit 113, and the transceiver unit 115 is coupled to the antenna power amplification unit 113. In other embodiments, the elements or configuration of the mobile communication unit 110 can be added, reduced, or changed according to at least one or more than one mobile communication mode. Thus, the mobile communication unit 110 is not limited to the above exemplification.

The processing unit 120, coupled to the mobile communication unit 110 for operating in a mobile communication mode (such as 3G mode), receives a mobile communication signal S, and accordingly verifies whether to allow a sender (such as the mobile device 10) of the mobile communication signal S to be linked to the auxiliary communication device 100. In an embodiment, the processing unit 120 can be realized by a baseband processing unit based on a microprocessor or a digital signal processor. If verification passes, then the processing unit 120 enables the auxiliary communication device 100 and the sender 10 to establish a first communication link LK1 in the mobile communication mode. The processing unit 120 sends the network configuration information PD to the sender 10 through the first communication link LK1.

In addition, the auxiliary communication device 100 of FIG. 1 can be realized as a communication device for assisting mobile data offloading.

In an embodiment, the auxiliary communication device 100 of FIG. 1 can be realized as a communication device for assisting mobile data offloading, which has the network configuration information PD of the wireless access device 130 and implements the method indicated in FIG. 3. In another embodiment, the auxiliary communication device 100 allows user setting. For example, the auxiliary communication device 100 has a user interface used for input setting or linked to other input device via an external link. Meanwhile, the communication device for assisting mobile data offloading can be realized as an independent device or a femtocell. In addition, based on the signal coverage area, the auxiliary communication device 100 can be disposed near the wireless access device 130. Thus, the mobile device 10, after activating the first wireless network mode, can access the network in the first wireless network mode readily.

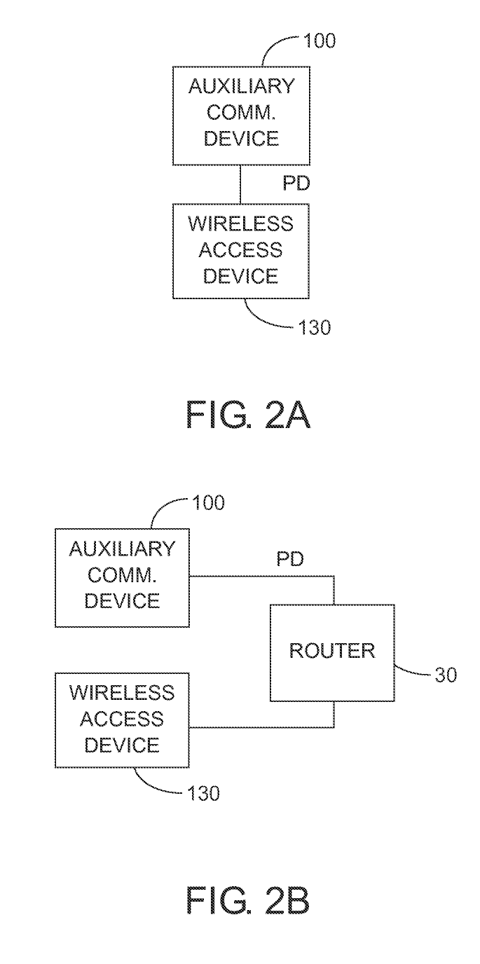

In another embodiment, a communication device for assisting mobile data offloading may include the auxiliary communication device 100 and the wireless access device 130 for implementing the method indicated in FIG. 3, such that the mobile device 10 and the wireless access device 130 establish a second communication link LK2 for performing network access. Meanwhile, the communication device for assisting mobile data offloading can be realized as a wireless access device or a femtocell. In another embodiment as indicated in FIG. 2A, the auxiliary communication device 100 can be coupled to the wireless access device 130 to obtain the network configuration information PD from the wireless access device 13. The processing unit 120 and the wireless access device 130 establish a link to obtain the network configuration information PD.

In another embodiment, the auxiliary communication device 100 can be linked to the router 30 to obtain the network configuration information PD from the wireless access device 130 as indicated in FIG. 2B.

FIG. 4 shows a flowchart of implementing a mobile data offloading method on a mobile device 10 according to one embodiment. As indicated in the embodiment of FIG. 1, when the mobile device 10 is near the auxiliary communication device 100 and the wireless access device 130, the mobile device 10 passes verification through the auxiliary communication device 100 to obtain permission for establishing a first communication link LK1, as indicated in step S410, the mobile device 10 establishes a first communication link in a mobile communication mode. Next, in step S420, the mobile device 10 obtains network configuration information of a first wireless network mode PD. In step S430, in response to the network configuration information PD, the mobile device 10 activates the mobile device 10 to enter the first wireless network mode. In step S440, the mobile device 10 performs network access by using the network configuration information PD in the first wireless network mode.

In an embodiment, the mobile device 10 and the auxiliary communication device 100 establish a first communication link. The auxiliary communication device 100, in a mobile communication mode, may send a message indicating the existence of a wireless access point. In step S420, the mobile device 10, in response to the message, sends a request to obtain corresponding network configuration information PD. In another embodiment, at the time when or after the mobile device 10 and the auxiliary communication device 100 establish a first communication link, the auxiliary communication device 100 may send a message (such as the network configuration information PD) indicating the existence of a wireless access point in a mobile communication mode. The transmission of the above message can be achieved according to existing specification of the mobile communication mode (such as 2G, 3G).

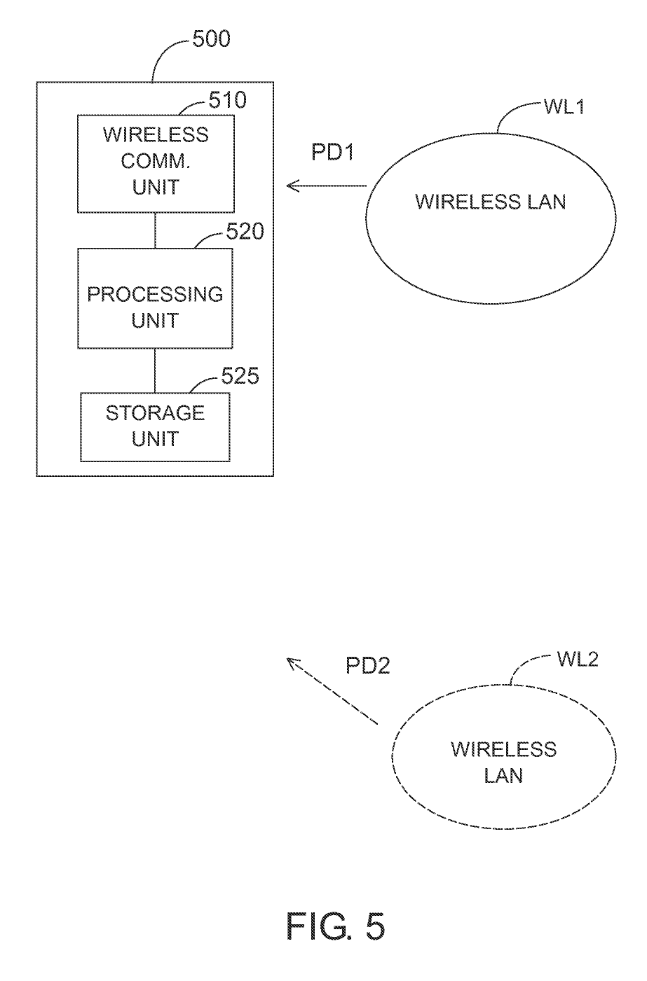

Referring to FIG. 5, a block diagram of a mobile device according to one embodiment is shown. The mobile device of FIG. 5 is capable of implementing the method indicated in FIG. 4. In FIG. 5, the mobile device 500 includes a wireless communication unit 510, a processing unit 520 and a storage unit 525. The wireless communication unit 510 selectively performs voice and data communication in a mobile communication mode, and selectively performs data communication in a first wireless network mode. The wireless communication unit 510 such as includes two sets of antennas corresponding to the mobile communication mode and the first wireless network mode respectively, and related communication components such as an amplifier and a receiver. The processing unit 520 is coupled to the wireless communication unit 510 and the storage unit 525 for operating the mobile device 500. When the mobile device 500 establishes a first communication link in the mobile communication mode and obtains network configuration information of a first wireless network mode, the processing unit 520, in response to the network configuration information, activates the mobile device 500 to enter the first wireless network mode and establishes a second communication link with a wireless access device in the first wireless network mode for performing network access. In an embodiment, the processing unit 520, in response to the network configuration information, enables the wireless communication unit to perform voice or data communication only in the mobile communication mode while performs network access (such as linked to the Internet) in the first wireless network mode. In an embodiment, the processing unit 520 stores the network configuration information to the storage unit 525.

FIG. 5 shows the mobile data offloading achieved by the mobile device in different wireless LANs. As indicated in FIG. 5, the wireless LANs WL1 and WL2 respectively have at least one communication device based on the embodiment of FIG. 1 for assisting mobile data offloading, and belong to different areas such as coffee shops, offices, reception rooms, household and school. Thus, when the mobile device 500 enters the coverage of the wireless LAN WL1, the mobile device 500 may obtain the network configuration information PD1 to be linked to the wireless access point of the current network to perform network access. When the mobile device 500 enters the coverage of another wireless LAN WL2, the mobile device 500 may obtain the network configuration information PD2 to be linked to the wireless access point of the current network to perform network access. Thus, the mobile device 500 can achieve mobile data offloading in different application occasions, so that the user is able to go online more conveniently in the wireless network mode, and communication resources can be used more effectively. In an embodiment, the processing unit 520 may store the network configuration information PD1 and PD2 to the storage unit 525 or an internal memory of the processing unit 520 so that the network configuration information PD1 and PD2 can be used next time when the mobile device 500 enters the coverage of the same wireless LAN.

At proper timing, the mobile device 500 may automatically switch the operation mode for Internet access in order to avoid unnecessary power consumption. For example, in an embodiment, the mobile device 500 automatically turns off the wireless network mode after the signal of the wireless LAN turns too weak or after a period of time, or the mobile device 500 selectively allows the first wireless network mode to be used as an Internet access mode after the wireless network mode has been turned off for a period of time.

The embodiments indicated in FIG. 4 and FIG. 5 can be implemented by way of software or firmware. For example, the method indicated in FIG. 4 or other embodiments can be implemented by installing programming modules or programming codes in the mobile device 500. In other embodiments, the above programming modules or programming codes can further be used in different occasions of application such as the communication device for assisting mobile data offloading, or the mobile device used in a business, school, or the client of a coffee shop or restaurant for automatically activating the first wireless network mode for getting online.

According to the above embodiments, the mobile device 10 or the mobile device 500 can be realized by different types of electronic devices such as a smart mobile phone, mobile Internet access device, tablet PC, e-book device, notebook computer, navigation device, and car PC.

According to the method and communication device for assisting mobile data offloading and the mobile device disclosed in the above embodiments, the mobile device can achieve mobile data offloading in different occasions of application, so that the user can go online more conveniently in the wireless network mode and the communication resource can be used more effectively. In addition, the embodiments of the method and communication device for assisting mobile data offloading allow the mobile device to perform verification and send the network configuration information without having to be linked to the core network of the mobile communication network. Thus, the implementation involves lower system complexity and is easier to be achieved along with the disposition of wireless LAN in different occasions of application.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A communication device for assisting mobile data offloading, comprising:
an auxiliary communication device, which sends network configuration information of a first wireless network mode to a sender corresponding to a mobile communication signal in a mobile communication mode, the auxiliary communication device includes:
a mobile communication unit;
a processing unit, coupled to the mobile communication unit, for operating in the mobile communication mode, wherein the processing unit receives the mobile communication signal, and accordingly verifies whether to allow the sender to be linked to the auxiliary communication device, and, if the verification passes, then the processing unit enables the sender to establish a first communication link with the auxiliary communication device in the mobile communication mode and sends the network configuration information to the sender through the first communication link, and the network configuration information is for activating the sender to enter the first wireless network mode in which network access is performed accordingly.

2. The communication device according to claim 1, wherein in the first wireless network mode, the network configuration information further enables the sender to establish a second communication link with a wireless access device.

3. The communication device according to claim 2, wherein the processing unit establishes a link with the wireless access device to obtain the network configuration information.

4. The communication device according to claim 1, further comprising:
a wireless access device, wherein in the first wireless network mode, the network configuration information further enables the sender to establish a second communication link with the wireless access device in which network access is performed accordingly.

5. The communication device according to claim 4, wherein the processing unit establishes a link with the wireless access device to obtain the network configuration information.

6. The communication device according to claim 1, wherein the network configuration information further enables the sender to pass the verification of the wireless access device to perform network access in the first wireless network mode.

7. The communication device according to claim 1, wherein the mobile communication mode is a mobile communication mode based on a cellular mobile communication network.

8. The communication device according to claim 7, wherein the first wireless network mode is a wireless network mode based on a wireless local area network.

9. A method for assisting mobile data offloading, wherein the method comprises:
receiving a mobile communication signal by an auxiliary communication device in a mobile communication mode, and accordingly verifying whether to allow a sender of the mobile communication signal to be linked to the auxiliary communication device;
enabling the sender to establish a first communication link with the auxiliary communication device in the mobile communication mode if the verification passes; and
sending network configuration information to the sender through the first communication link, wherein the network configuration information is for activating the sender to enter the first wireless network mode in which network access is performed accordingly.

10. The method for assisting mobile data offloading according to claim 9, wherein the network configuration information further is used for making the sender pass the verification to perform network access in the first wireless network mode.

11. The method for assisting mobile data offloading according to claim 9, wherein the mobile communication mode is a mobile communication mode based on a cellular mobile communication network.

12. The method for assisting mobile data offloading according to claim 11, wherein the first wireless network mode is a wireless network mode based on a wireless LAN.

13. A mobile device, comprising:
a wireless communication unit for selectively performing voice and data communication in a mobile communication mode and selectively performs data communication in a first wireless network mode;
a storage unit; and
a processing unit, coupled to the wireless communication unit and the storage unit, for operating the mobile device, wherein when the mobile device being in the mobile communication mode establishes a first communication link and obtains network configuration information of a first wireless network mode, the processing unit, in response to the network configuration information, activates the mobile device to enter the first wireless network mode in which network access is performed accordingly.

14. The mobile device according to claim 13, wherein the processing unit, in response to the network configuration information, enables the wireless communication unit and a wireless access device to establish a second communication link in the first wireless network mode.

15. The mobile device according to claim 14, wherein the processing unit passes verification of the wireless access device by using the network configuration information to perform network access in the first wireless network mode.

16. The mobile device according to claim 13, wherein the processing unit, in response to the network configuration information, enables the wireless communication unit to perform voice or data communication only in the mobile communication mode.

17. The mobile device according to claim 13, wherein the mobile communication mode is a mobile communication mode based on a cellular mobile communication network.

18. The mobile device according to claim 17, wherein the first wireless network mode is a wireless network mode based on a wireless local area network.
